(19) United States
(12) Patent Application Publication
(10) Pub. No.: US 2018/0354110 A1
(43) Pub. Date: Dec. 13, 2018

(54) RELEASABLE SEF-LOCKING DEVICE AND METHOD FOR USING SAME TO REPLACE BUSHINGS

(71) Applicant: Gordian Enterprises Inc., Beaumont (CA)

(72) Inventors: Frank McIsaac, Beaumont (CA); Paul Clements, Leduc County (CA)

(21) Appl. No.: 15/618,271

(22) Filed: Jun. 9, 2017

(51) Int. Cl. B25B 27/06

(52) U.S. Cl. CPC B25B 27/06; F16C 17/02

(57) ABSTRACT

A releasable self-locking device which may be installed upon a central shaft (such as a hexagonal shaft), such that it can freely slide along the shaft in a first direction, but provides releasable locking engagement along the shaft in a second direction. The use of such a releasable self-locking device in combination with a hexagonal shaft as a bushing removal and bushing installation tool.

### FIELD OF THE INVENTION

The present invention relates to the field of automotive and industrial tools, more specifically to tools for removing and installing bushings in a variety of applications.

### BACKGROUND/DESCRIPTION OF THE RELATED ART

Generally, a mechanical bushing (also sometimes referred to as a plain bearing) is a cylindrical lining, sleeve or spacer that is configured to be housed within a cylindrical cavity, and used to reduce friction and wear inside such cylindrical cavity, or to constrict and restrain motion of mechanical parts. For example, bushings are often found in vehicle suspension systems, excavators, aggregate equipment, and pump housings. Typically, bushings are designed to fit very tightly within such cylindrical cavities. Bushings can be made from materials such as various metals, plastics, and numerous other materials.

Due to the nature of their use, bushings wear out over time and cease to sufficiently hold the components that pass through them in place. The damaged or worn-out bushings must then be removed from the cylindrical cavities within which they are tightly housed, and replaced with new bushings. Bushings can be removed and installed by various mechanical means. In many applications, a hollow hydraulic cylinder is utilized along with a threaded shaft assembly to remove and install bushings. Depending on the type of system involved, it is not uncommon for a large number of bushings to all have to be replaced in succession.

Hydraulically removing bushings requires the use of various components. One conventional method (sometimes referred to herein as the “threaded shaft method”) comprises a hollow hydraulic cylinder, a hydraulic power pack to actuate the hydraulic cylinder, a sufficiently sized hollow cylindrical sleeve which has an inner diameter that is larger than the outer diameter of the bushing to receive the bushing when removing it, a length of threaded shaft, a thick washer which has an outer diameter slightly smaller than the outer diameter of the bushing, and one or more nuts on each end of the threaded shaft to keep the assembly captive while operating on the bushing. To remove the bushing, the threaded shaft is passed through the bushing and the thick washer is placed onto the threaded shaft and pushed up against the bushing. Next, a washer and a nut are installed on the same end to press up against the thick washer. A hollow cylindrical sleeve is then slid over the threaded rod from the opposite side of the thick washer. A hollow hydraulic cylinder is then slid onto the threaded shaft and pressed up against the hollow cylindrical sleeve. The hollow hydraulic cylinder is followed by a washer and a nut. The nut is spun on the threaded shaft until the assembly is held tightly together. Finally, hydraulic force is applied to pull the bushing from its housing and into the receiving cylinder. Some bushings are longer than the stroke of the hydraulic cylinder, so the bushing must be pulled out in multiple steps, tightening the nuts on either end of the threaded shaft after each step.

Hydraulically installing bushings requires the use of similar components as for hydraulically removing bushings. When installing the bushing, it is often not necessary to use the cylindrical receiving sleeve since the thick washer pushes directly on the bushing as it is installed. Some applications may require the receiving sleeve, for example, if the bushing sticks out past the end of the housing on each side.

Through repeated use, or because of improper storage, the threaded shaft can become more difficult to use. It may become dirty due to the environment that it is used in. It may also get damaged through use and improper storage. In particular, once the threaded shaft becomes dirty or damaged, hand tools may be required to hold the threaded shaft to prevent it from rotating while the nuts are spun into place with a wrench. This slows the mechanic's progress and adds significant time and frustration to the process. The time required to complete a removal or installation is amplified when a bushing must be pulled out or installed in multiple steps. Each time the cylinder reaches the end of its stroke and is collapsed back in, the nut must be spun further up the threaded shaft to continue the operation. After the operation is complete, the nut must be spun further off the threaded shaft to remove it.

### BRIEF SUMMARY OF THE INVENTION

Disclosed herein is a releasable self-locking device for use with a shaft. More specifically, the releasable self-locking device and shaft may be utilised as a tool for removing and installing bushings. A preferred embodiment of the bushing removal tool comprises a hexagonal shaft and a releasable self-locking device. The hexagonal shaft has two opposing ends, one of which is threaded. The releasable self-locking device utilizes a plurality of jaws, each with an internal angled slot and external teeth. The jaws are supported by guide pins which sit inside the slot in the jaws and are held in place in the main body of the releasable self-locking device. Once the device is slid onto the hexagonal shaft, springs are used to hold the jaws against the hexagonal shaft. When axial force is applied on the self-locking device in a direction opposite to the direction in which the self-locking device was installed, the teeth on the jaws start to frictionally engage and bite into the hexagonal shaft. As the teeth on the jaws bite, the jaws travel on the supporting guide pins and are pulled inwards toward the centre of the shaft. As more force is applied on the releasable self-locking device axially in the direction opposite to the direction of installation, the jaws push harder toward the centre of the shaft and bite harder. In this configuration, the releasable self-locking device functions as a one-directional lock, i.e. it is allowed to slide/move along the shaft in one direction (the direction from which it was installed onto the hexagonal shaft, sometimes referred to herein as the non-locking direction), but it locks against movement in the opposite direction (the direction opposite to which it was installed, sometimes referred to herein as the locking direction). As mentioned above, once the jaws of the releasable self-locking device are engaged on the hexagonal shaft, if additional force is applied to the self-locking device axially in the locking direction (or put another way, if the hexagonal shaft is pulled axially from the self-locking device in a non-locking direction), this operates to pull the jaws closer towards the axis of the hexagonal shaft and thus bite harder.

The releasable self-locking device is configured with a release ring, which when squeezed by the operator, acts against the spring force and lifts the jaws from the surface of the hexagonal shaft, thereby releasing the releasable self-locking device. Once the releasable self-locking device is released from the hexagonal shaft, it can be pushed back along the hexagonal shaft in the locked direction, and removed if desired. Some of the advantages of the tool include the following:
The releasable self-locking device is simply pushed onto the shaft and may be quickly slid into the desired location along the shaft and locked, without requiring the user to make many turns of a locking nut.
The releasable self-locking device requires no additional tools to install or remove it on a hexagonal shaft.
The jaws inside the releasable self-locking device allow it to lock onto the shaft in any location.
When removing or installing a bushing in multiple stages due to limited hydraulic cylinder stroke, the releasable self-locking device is simply slid further onto the hexagonal shaft.
In contrast to the conventional threaded shaft and nut method, damage to the shaft can help the jaws bite quicker and easier.
The jaws are designed to self-locate in that they can rotate around their support pin. This allows them to bite onto the shaft more easily. This also allows them to bite onto the shaft even after the shaft has become bent.
The release ring allows the operator to quickly and easily remove the releasable self-locking device.

The present invention addresses some of the disadvantages related to the use of the threaded shaft when removing or installing bushings hydraulically. A hexagonal shaft replaces the threaded shaft. The hexagonal shaft is placed through the bushing just as the threaded shaft would be. One end of the hexagonal shaft will receive the thick washer and will be held in place with a flanged nut or securing nut; the securing nut does not need to be removed during the removal or installation of the bushing. The other end of the hexagonal shaft will receive the hollow hydraulic cylinder and the releasable self-locking device. The releasable self-locking device is simply pushed along the shaft toward the hydraulic cylinder until the assembly is tight. Hydraulic force is then applied by use of the hydraulic cylinder to remove the bushing. Once completed, the releasable self-locking device is quickly released and slid back off the hexagonal shaft.

Similar to a threaded shaft in the threaded shaft method, the hexagonal shaft will become dirty and damaged through use. However, the releasable self-locking device will continue to work as though the hexagonal shaft was new. The self-locking device does not rely on a specifically formed shaft to hold it in place. Rather, it will hold onto the hexagonal shaft at any location and it self-locates on rough surfaces because the jaws can be configured to pivot to follow the contours of the central shaft.

### BRIEF DESCRIPTION OF THE DRAWINGS

Embodiments of the present invention are described below with reference to the accompanying drawings in which:

FIG. 1 is an isometric view of an embodiment of the releasable self-locking device.

FIG. 2 is an isometric exploded view of the bushing removal tool.

FIG. 3 is a front view of the bushing removal tool, with the spring cap of the releasable self-locking device removed and the teeth of the jaws engaged on the hexagonal shaft.

FIG. 4 is a sectional view of the bushing removal tool showing the jaws of the releasable self-locking device engaged on the hexagonal shaft.

FIG. 5 is a sectional view of the bushing removal tool showing the jaws of the releasable self-locking device disengaged from the hexagonal shaft.

FIG. 6 is an isometric sectional view of the bushing removal tool, showing the release ring holding the jaws disengaged from the hexagonal shaft and showing the springs pushing on the jaws opposite the release ring.

FIG. 7 is a sectional view showing the setup, including the bushing removal tool, used to remove a bushing from its bushing housing.

FIG. 8 is a sectional view of the bushing removal tool in operation, wherein a bushing is shown partially removed.

FIG. 9 is a sectional view showing the setup used to install a bushing into a bushing housing.

FIG. 10 is a sectional view of the bushing removal tool in operation, wherein the bushing is shown partially installed.

FIG. 11 is a sectional view of the releasable self-locking device, shown installed upon a hexagonal shaft that has been deformed, and showing the jaws engaged with the hexagonal rod.

FIG. 12 is a sectional view of another embodiment of the releasable self-locking device, installed upon a hexagonal shaft.

FIG. 13 is an isometric view of the embodiment of the releasable self-locking device of FIG. 12, installed upon a hexagonal shaft.

### DETAILED DESCRIPTION OF THE INVENTION

The present invention now will be described more fully hereinafter with reference to the accompanying drawings, which form a part hereof, and which show, by way of illustration, exemplary embodiments by which the invention may be practiced. The invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

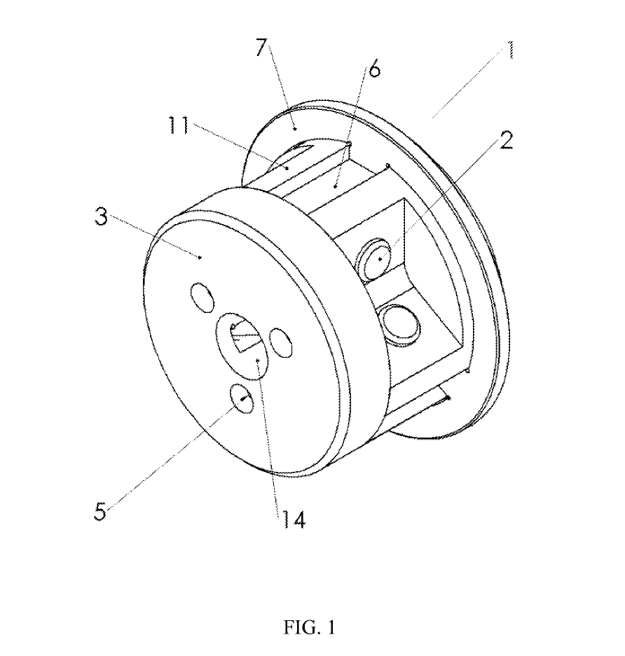

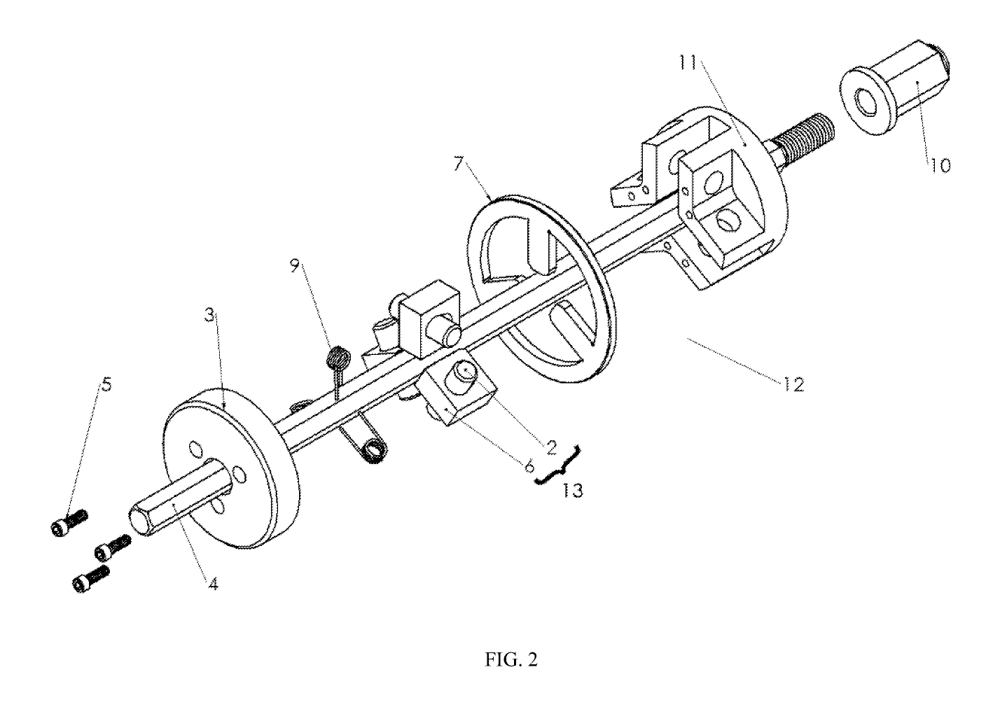

An isometric view is shown of a releasable self-locking device 1 in FIG. 1. The component parts of the releasable self-locking device 1 can be more clearly seen in FIG. 2, and are discussed in greater detail below. In terms of what is visible from the view in FIG. 1, the releasable self-locking device 1 is shown as having a main body 11, a locking assembly 13 (having a plurality of jaws 6 and a plurality of guide pins 2), a spring cap 3, a plurality of cap screws 5, and a release ring 7.

Referring to FIG. 2, an exploded isometric view of a bushing removal tool 12 is shown, which comprises the releasable self-locking device 1, a hexagonal shaft 4 and a securing nut 10. As can be seen, the hexagonal shaft 4 is threaded at one end. The securing nut 10 can be screwed onto the threaded end of the hexagonal shaft 4 and operates to secure a workpiece (such as a bushing that has been installed into a bushing housing) and prevent it from slipping off the hexagonal shaft 4. The releasable self-locking device 1 comprises: shaft 4, a main body 11; a release ring 7; a locking assembly 13 (comprising a plurality of jaws 6 and guide pins 2); a set of springs 9; a spring cap 3 and one or more cap screws 5. Jaws 6 are held in place inside the main body 11 by guide pins 2. The set of springs 9 is secured inside spring cap 3. The spring cap is affixed to the main body 11. Preferably, the spring cap is detachably affixed to the main body 11, so as to allow the inside of the releasable self-locking device 11 and its internal components to be more easily accessed, (e.g. for purposes of repair/maintenance, etc.). In the preferred embodiment, the spring cap is affixed to the main body 11 using a plurality of cap screws 5.

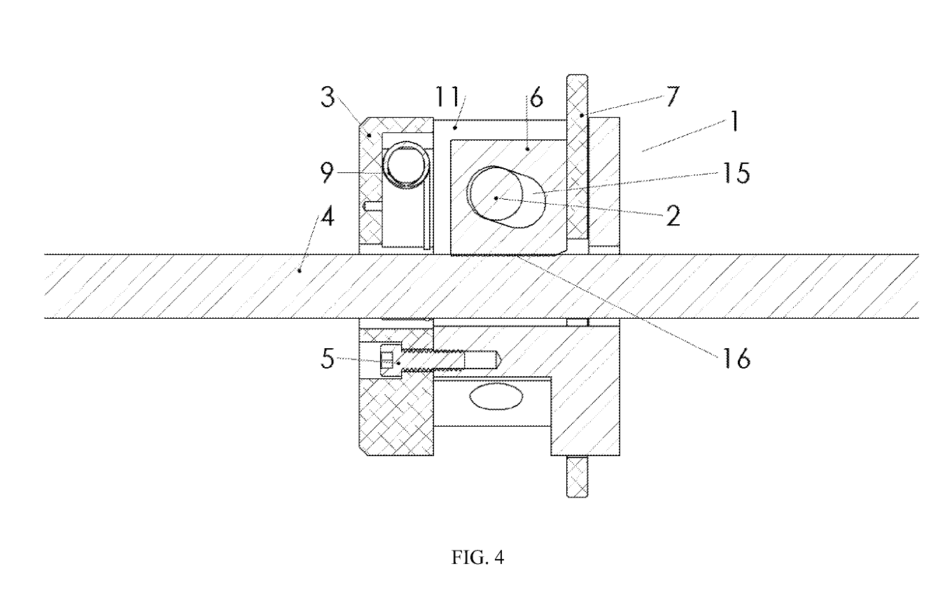

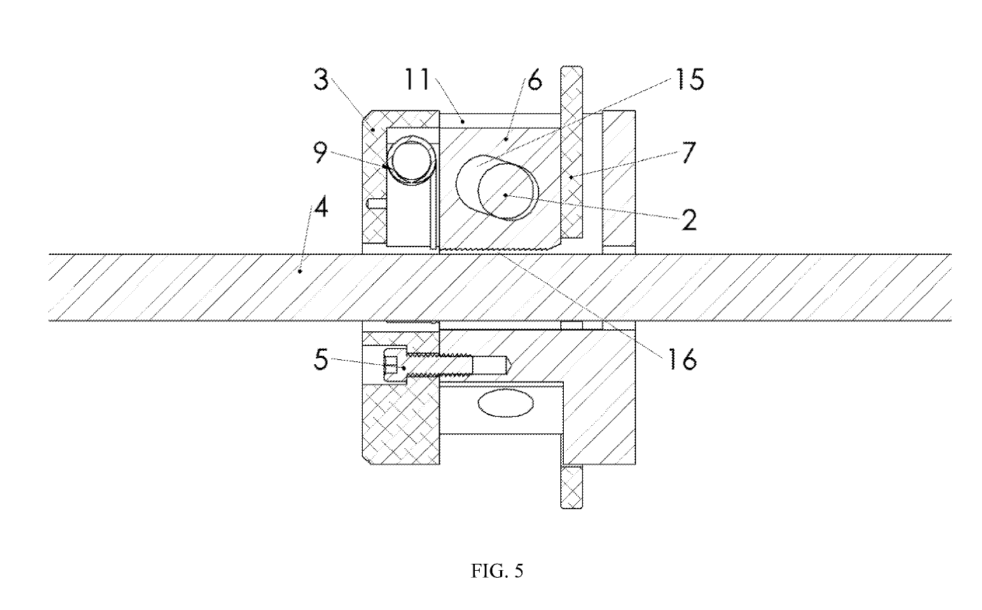

A locking assembly 13 is housed within the main body 11, and is configured with one or more jaws 6 and one or more guide pins 2. Each guide pin 2 matingly engages with a corresponding angled slot 15 within each jaw 6 and functions to guide the movement of each jaw 6 relative to the main body 11. (The operation of the locking assembly 13 can be better seen in FIGS. 4 and 5 below, and is further described below). Each angled slot 15, which may be machined directly into the jaws 6, defines a channel bounded by sliding surfaces within the locking assembly 13, within which the corresponding guide pin 2 can move. A set of springs 9 is configured such that each spring pushes axially on a corresponding jaw 6, the springs 9 being mounted between the jaws 6 and spring cap 3. The springs 9 operate to bias each corresponding jaw 6 towards an engaged position, which is the position that the jaws are in when “at rest”. The springs 9 are configured so that when the releasable self-locking device 1 is installed on the hexagonal shaft 4, the teeth 16 of the jaws 6 will sit on or proximate to the surface of the hexagonal shaft 4. However, it should be understood that it is not the springs 9 that cause the jaws 6 to lock the releasable self-locking device 1. The springs 9 simply bias the jaws 6 against the surface of the hexagonal shaft 4, sufficiently firmly such that, when the releasable self-locking device 1 is pulled from the hexagonal shaft 4 in the locking direction (upon application of a force), the interaction of each guide pin 2 and its corresponding angled slot 15 causes the teeth 16 of the jaws 6 to lock on the hexagonal shaft 4. Upon such application of a force on the releasable self-locking device 1 in the locking direction, the hexagonal shaft is pulled back in the opposite direction, each guide pin 2 cooperates with the corresponding angled slot to cause the jaws 6 to move towards the centre of the hexagonal shaft 4, thus causing the teeth 16 of the jaws 6 to bite into the hexagonal shaft 4 and lock thereon. That is, the sliding surfaces defining the channels that the pins 2 are seated in, being angled with respect to the central shaft, confine the jaws 6 to move along a trajectory that moves the jaws 6 towards the central shaft 4 when the locking device 1 moves along the shaft in the locking direction, causing the jaws 6 to move oppositely to the locking direction relative to the locking device 1.

Thus, when the bushing removal tool 12 is to be used, the releasable self-locking device 1 has to be installed onto the hexagonal shaft 4 via the opening 14 in the releasable self-locking device 1 and positioned in the desired position along the hexagonal shaft 4. The releasable self-locking device 1 functions as one-direction lock in that it is free to slide onto the hexagonal shaft 4 (i.e. in the non-locking direction), but is constrained from being able to slide backwards along the hexagonal shaft 4 (i.e. in the locking direction). Indeed, once the releasable self-locking device 1 is installed upon the hexagonal shaft 4, it can readily be pushed further along the hexagonal shaft 4 in the non-locking direction, including, for example, until it abuts or is proximate to an adjacent workpiece. When a force is applied to the self-locking device 1 in the non-locking direction, any friction against the hexagonal shaft 4 will cause the jaws 6 to push back on the springs 9 and move out of the way. In order to slide the releasable self-locking device 1 backwards along hexagonal shaft 4 (i.e. in the locking direction)(e.g. when repositioning or removing the releasable self-locking device 1), the jaws 6 generally must first be released into a disengaged position e.g. via actuation of the release ring 7 (discussed in more detail below), before the releasable self-locking device 1 is free to slide backwards along the hexagonal shaft 4.

Further, as an optional feature, each of the jaws 6 are preferably configured, as shown, to be pivotable about the axis of a corresponding guide pin 2 to follow the contours of the surface of the central hexagonal shaft 4 (e.g. in the event the surfaces of the hexagonal shaft 4 are slightly irregular or become rough), such that they self-locate for better frictional engagement with the hexagonal shaft 4. Although the guide pins 2 preferably have a circular cross section, as shown, since this naturally allows the jaw to pivot about the axis of the guide pin, it is contemplated that the guide pins could have other shapes and still function. By way of example, the guide pins 2 could have a generally square-shaped cross section, although in this case, the jaws 6 would not be pivotable. The releasable self-locking device 1 can accordingly be used as a lock that, when the jaws 6 are in an engaged position, functions to constrain the axial movement along a central shaft in one direction; the self-locking device 1 can be configured to quickly disengage from and release such central shaft when desired, via use of a release ring 7 to simultaneous disengage the jaws 6.

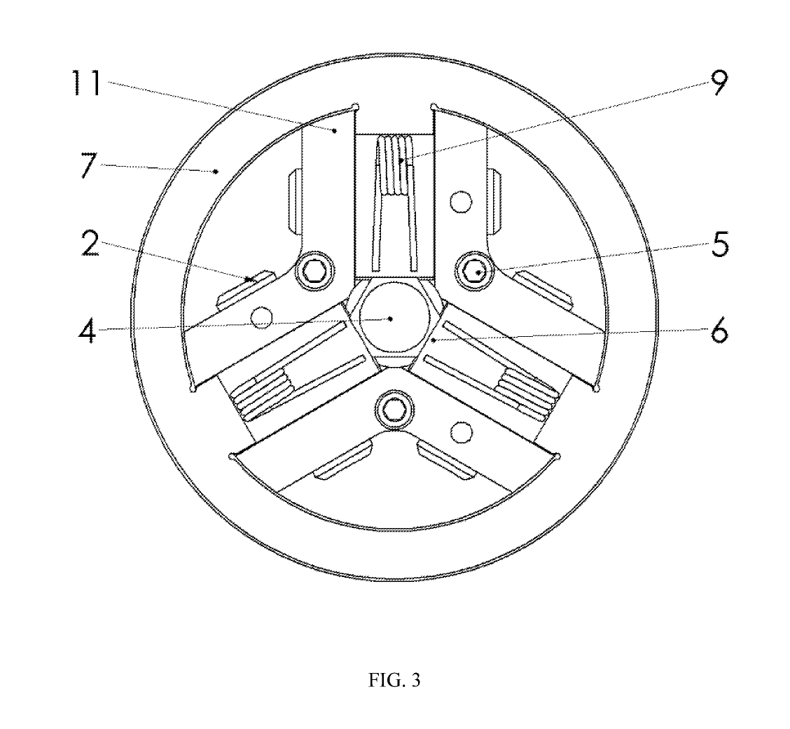

FIG. 3 presents a front view of the bushing removal tool 12, with the spring cap 3 of the releasable self-locking device 1 removed and the teeth of the jaws 6 engaged on the hexagonal shaft 4.

FIG. 4 is a sectional view of the bushing removal tool 12, showing the jaws 6 of the releasable self-locking device 1 in an “engaged” position; in this engaged position, the teeth 16 of the jaws 6 are biased upon the hexagonal shaft 4. As previously described, after a force is applied on the self-locking device 1 in the locking direction, this causes the guide pin 2 and the angled slot to cooperate such that the jaws 6 move towards the centre of the hexagonal shaft 4, causing the teeth 16 on the jaws 6 to “bite” on the surface of the hexagonal shaft 4, thereby locking the releasable self-locking device's position on the hexagonal shaft 4 against movement in the general direction of the spring cap 3 (or locking direction).

In order to disengage the jaws 6 of the releasable self-locking device 1 from this engaged/locked position and place them into a disengaged position, the release ring 7 may be actuated by the user pulling the release ring in the general direction of the spring cap 3. This in turn forces the jaws 6 towards the spring cap 3. Once the force exerted on the release ring is greater than the combined spring force from the springs 9, the jaws 6 move in the general direction of the spring cap 3. Due to the interaction between the guide pins 2 and the angled slots 15, as the jaws 6 move axially toward the spring cap 3 (i.e. in the locking direction), the guide pins 2 guide the jaws 6 to move radially away from the centre of the hexagonal shaft 4, thus releasing the self-locking device 1 from the hexagonal shaft 4. When the self-locking device 1 is in such disengaged position, it can readily and freely slide on and along the hexagonal shaft 4, including in the locking direction. Once the release ring 7 is released, the springs 9 push axially on the jaws 6 and the release ring 7, thereby returning the jaws 6 to their tightest radial position. FIG. 5 is a sectional view of the bushing removal tool 12, showing the jaws 6 in such “disengaged” position.

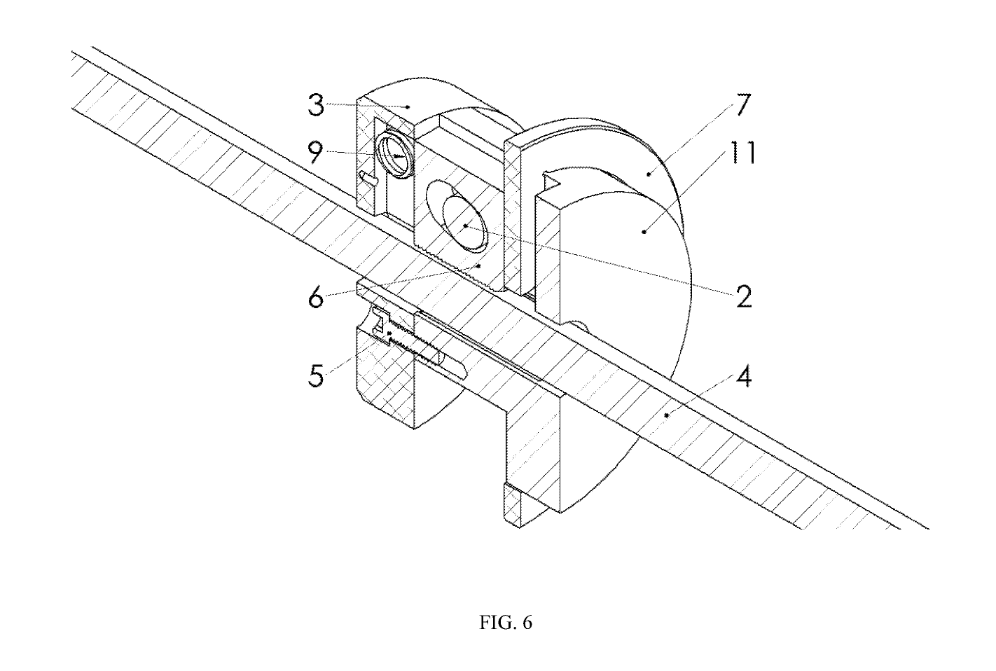

Referring to FIG. 6, this is an isometric sectional view of the bushing removal tool, showing the release ring 7 holding the jaws 6 in a disengaged position, disengaged from the hexagonal shaft 4. In this position, the springs 9 are pushing back on the jaws 6 in opposition to the direction of the release ring 7.

Although the shaft (i.e. the hexagonal shaft 4) that the releasable self-locking device 1 engages with is illustrated herein as having a cross-section that is hexagonally shaped, it will be apparent to one skilled in the art that differently shaped shafts may also be used, e.g. round, square, octagonal, etc. Accordingly, the releasable self-locking device 1 would then preferably be adapted to work with such a shaft. By way of example, if an octagonal shaft was used, the releasable self-locking device may be configured to have four jaws 6 (along with corresponding guide pins and springs therefor) that function to engage the surfaces of the shaft. It is contemplated that different shafts and configurations for the releasable self-locking device may be used, provided there is enough friction when the jaws engage with the shaft such that the releasable self-locking device 1 maintains its position on the shaft 4. Possible options not specifically illustrated herein, include knurling the shaft, machining a specific profile into the shaft, or other similar methods that achieve a “linear ratchet” effect. Further, the main function of the teeth 16 of the jaws 6 is that they enable frictional engagement with the shaft in one direction; as such, it should be appreciated that they can take various forms, including various known friction modifiers. In addition, the teeth 16 can be configured to take into account the nature/shape of the shaft used (e.g. the teeth and jaws, rather than being generally flat as illustrated herein, may be configured to be in a curved orientation to better engage with a cylindrically-shaped shaft or a threaded rod).

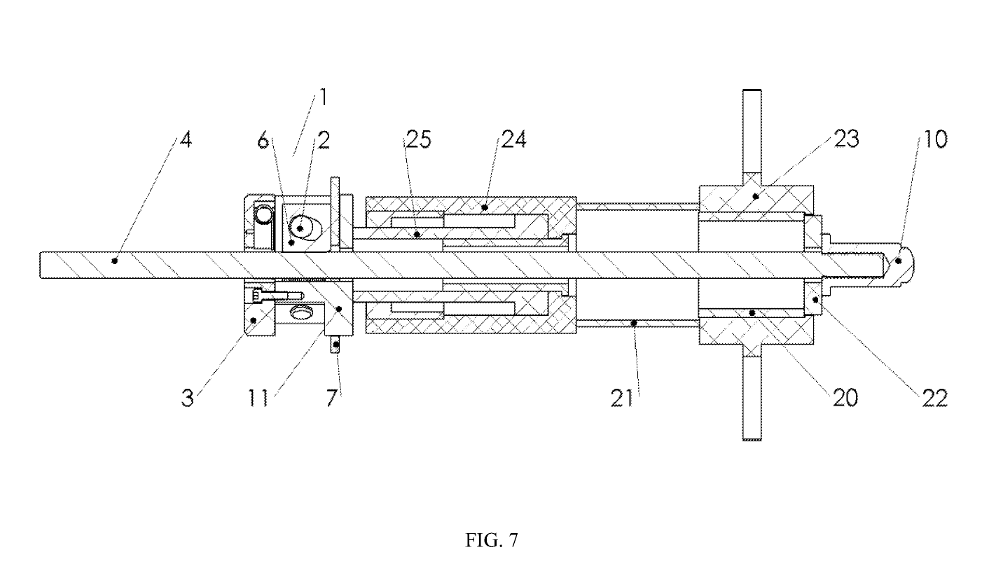

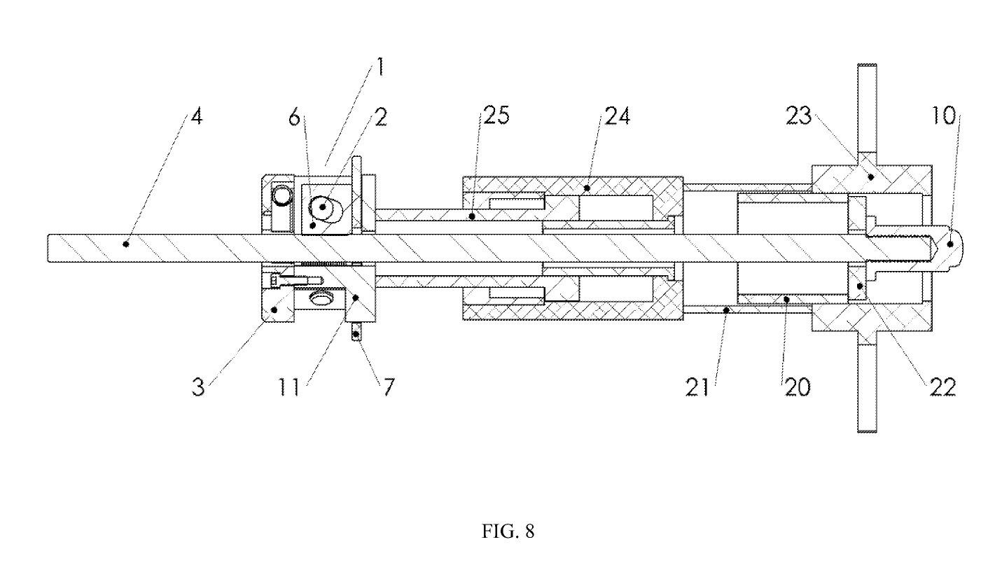

FIGS. 7-10 illustrate the bushing removal tool in operation, where it is used in combination with various components in order to remove / install a bushing 20. FIGS. 7 and 8 show an exemplary embodiment of the method by which the bushing removal tool 12 can be utilised to remove an installed bushing 20 from a bushing housing 23. Referring to FIG. 7, the hexagonal shaft 4 is placed through the inner diameter of bushing 20 from the right. It is slid through bushing 20 until a pulling washer 22 is sandwiched between securing nut 10 and the bushing 20. The pulling washer 22 generally has an outer radius that is greater than the inner radius of the bushing 20 but less than the outer radius of the bushing 20, such that there is sufficient overlap to enable the pulling washer 22 to apply a force and act on the edges of the bushing 20. A pulling sleeve 21 is slid over the hexagonal shaft 4 from the left side and pushed up to the bushing housing 23. The pulling sleeve 21 serves to receive the bushing 20 as the bushing 20 is removed from the bushing housing 23; as such the pulling sleeve 21 generally has an inside radius that is greater (preferably slightly greater) than the outside radius of the bushing 20. A hollow hydraulic cylinder 24 is then slid over the hexagonal shaft 4 from the left and placed such that it abuts the pulling sleeve 21. The releasable self-locking device 1 is then slid onto hexagonal shaft 4 from the left until the main body 11 abuts the hydraulic cylinder ram 25. Once the assembly is secure, hydraulic pressure is axially applied through use of the hollow hydraulic cylinder 24. As the hydraulic ram 25 is forced axially to the left (in the locking direction) by hydraulic pressure in the hollow hydraulic cylinder 24, the jaws 6 grasp onto the hexagonal shaft 4 and pull the hexagonal shaft 4 axially to the left. As hexagonal shaft 4 moves to the left, it pulls the securing nut 10, the pulling washer 22, and the bushing 20 with it.

Referring to FIG. 8, bushing 20 is shown part-way inside the pulling sleeve 21. If the bushing 20 is longer than the stroke of the hydraulic cylinder ram 25, then further cycles of pulling will be required to be applied in order to completely remove the bushing 20 from the bushing housing 23. To do so, the hydraulic pressure is first released, the hydraulic ram 25 is pulled back into the body of the hollow hydraulic cylinder 24 and the releasable self-locking device 1 is pushed further along the hexagonal shaft 4 (so that it abuts the hydraulic cylinder ram 25); then the hydraulic pressure is reapplied, which has the effect of pulling the bushing 20 further out from the bushing housing 23. Once the bushing 20 is completely removed from the bushing housing 23 and sitting inside the pulling sleeve 21, the releasable self-locking device 1 can be removed from hexagonal shaft 4. Release ring 7 is pulled toward spring cap 3 to pull the jaws 6 into a disengaged position away from hexagonal shaft 4. The releasable self-locking device 1 is then slid off the hexagonal shaft 4 to the left, freeing the remainder of the components for easy disassembly without the need for any tools.

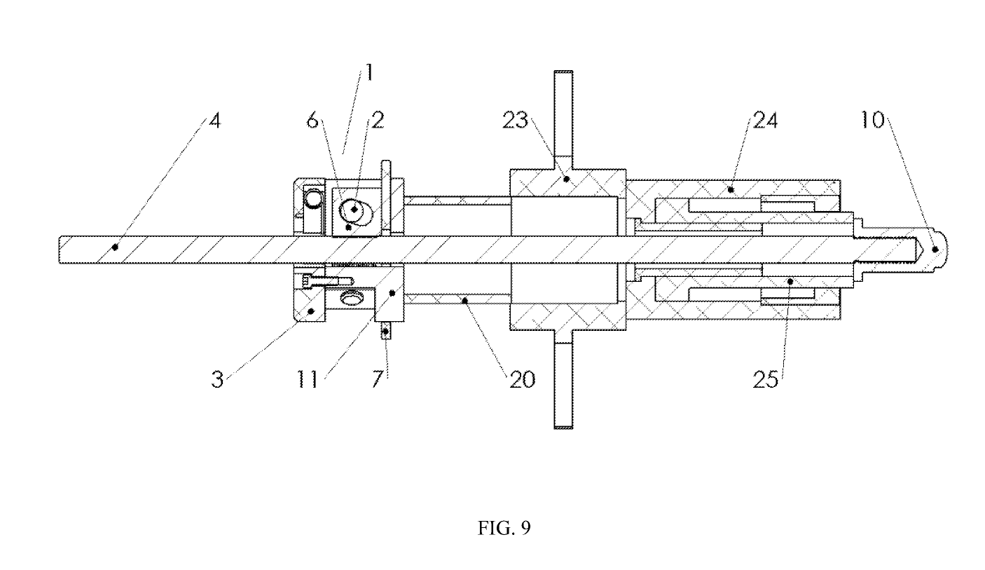

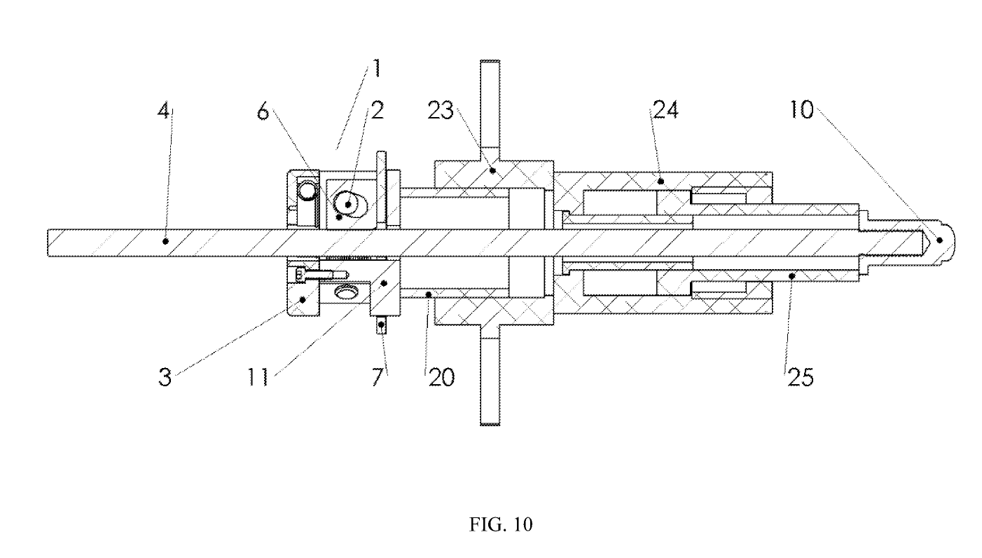

FIGS. 9 and 10 show an exemplary embodiment of the method by which the bushing removal tool 12 can be utilised to install a new or replacement bushing 20 into a bushing housing 23. Referring to FIG. 9, the hexagonal shaft 4 is slid through the hollow hydraulic cylinder 24 from the right until the securing nut 10 abuts the hydraulic ram 25. The hexagonal Shaft 4 is then placed through the bore of the bushing housing 23 until the hollow hydraulic cylinder 24 abuts the bushing housing 23. The bushing 20 is placed over the hexagonal shaft 4 from the left and slid up to the bushing housing 23. Lastly, the releasable self-locking device 1 is slid onto hexagonal shaft 4 and pushed up to abut with the bushing 20. As the hydraulic ram 25 is forced axially to the right by the application of hydraulic pressure in the hollow hydraulic cylinder 24, the hexagonal shaft 4 is pulled to the right. The jaws 6 grasp the hexagonal shaft 4 and consequently pull the main body 11 to the right. As the main body 11 moves to the right, it presses the bushing 20 into the bushing housing 23.

Referring to FIG. 10, the bushing 20 is shown partially installed in the bushing housing 23. If the bushing 20 is longer than the stroke of the hydraulic cylinder ram 25, then further cycles of pulling will be required to be applied in order to completely install the bushing 20 into the bushing housing 23. To do so, the hydraulic pressure is released, the hydraulic ram 25 is pulled back into the body of the hollow hydraulic cylinder 24, the hexagonal shaft 4, hollow hydraulic cylinder 24 and securing nut 10 are pushed to the left until the hollow hydraulic cylinder 24 abuts bushing housing 23 and the releasable self-locking device 1, is pushed further along the hexagonal shaft 4 to the right (non-locking direction) until releasable self-locking device 1 abuts the bushing 20; then the hydraulic pressure is reapplied, which has the effect of pushing the bushing 20 further into the bushing housing 23. Once the bushing 20 is completely installed in the bushing housing 23, the releasable self-locking device 1 can be easily removed from hexagonal shaft 4. The release ring 7 is pulled in the general direction of the spring cap 3 to pull the jaws 6 away from the hexagonal shaft 4. The releasable self-locking device 1 is then slid off the hexagonal shaft 4 to the left, freeing the remainder of the components for easy disassembly without the need for any tools.

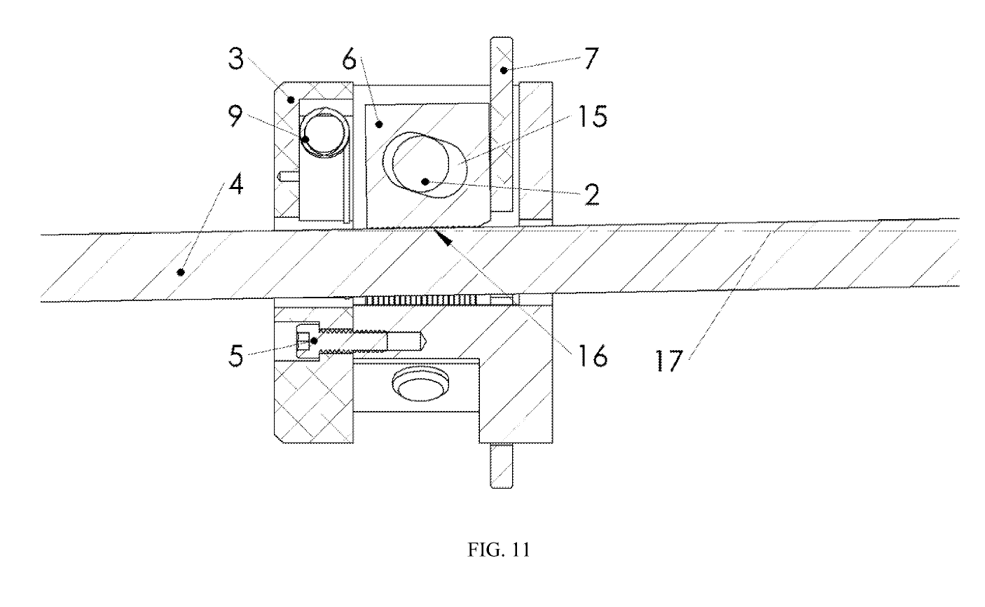

FIG. 11 is a sectional view of the releasable self-locking device 1, shown installed upon a hexagonal shaft that has been bent/deformed. This illustrates how the releasable self-locking device 1 can operate even in instances where the central shaft has been damaged or undergone wear-and-tear, in contrast to the conventional “threaded shaft” method. (This could also be the case if the hexagonal shaft 4 was not bent, but was not passed straight through the releasable self-locking device 1). In this example, the jaws 6 can slightly pivot about the guide pin 2. This results in better frictional engagement with the deformed central shaft (than if the jaws 6 remained horizontal). Thus, although the central shaft 4 is bent, the teeth 16 of the jaws 6 can nevertheless “bite” on and frictionally engage the central shaft.

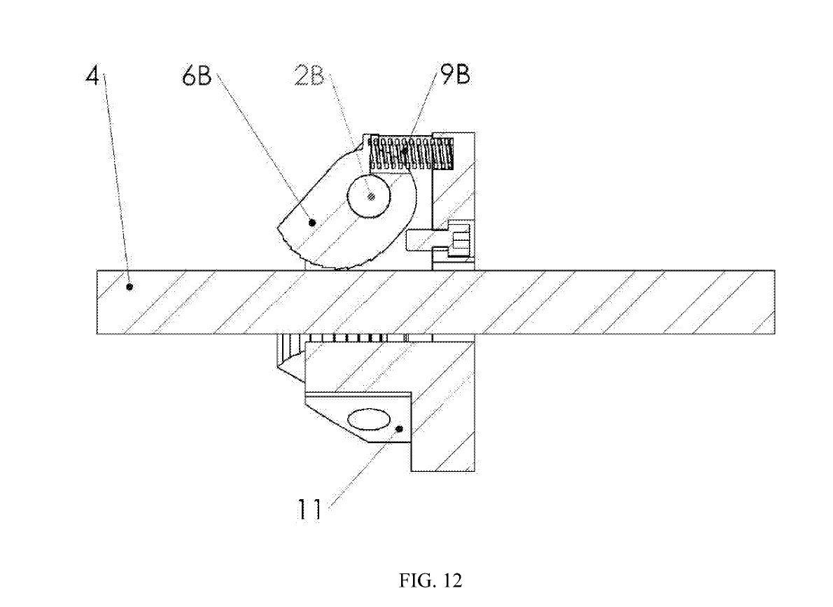

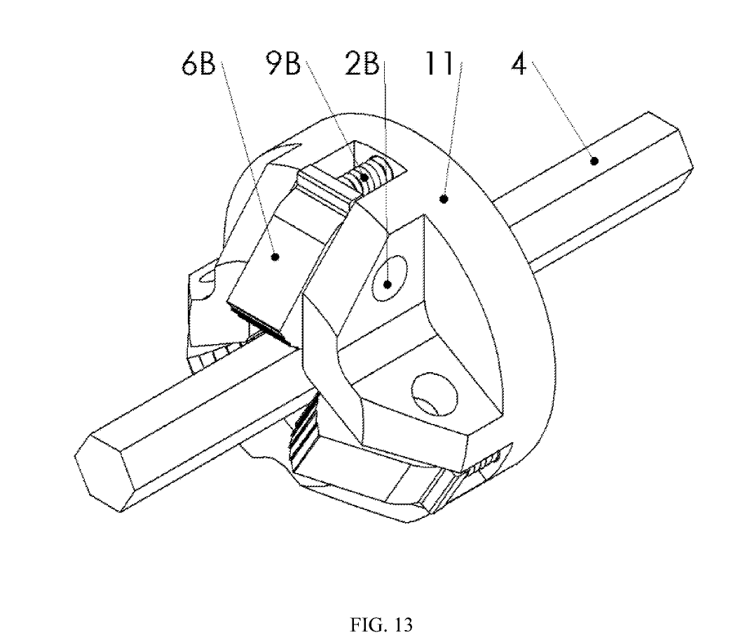

FIGS. 12 and 13 are respectively, a sectional view and an isometric view, of an exemplary alternative embodiment of the releasable self-locking device 1, installed upon a hexagonal shaft 4. In this particular embodiment, the jaws are in the form of cam-shaped jaws 6B, which pivot about a guide pin 2B. The surfaces of the guide pin 2B and the openings in which the guide pin 2B are received in the main body of the alternative embodiment of device 1 define surfaces that confine the jaws 6B to rotate around the center of the guide pins 2B and move towards the central shaft 4 when the device 1 is moved in a locking direction. A spring 9B functions to bias the cam-shaped jaw 6B against the central shaft 4. The cam-shaped jaws 6B are configured and positioned such that when the releasable self-locking device 1 is installed upon a central shaft, it can freely slide in one direction (non-locking direction, but if it is pulled in a locking direction, the cam-shaped jaws operate to provide increasing frictional force against the central shaft 4. The teeth of the jaws 6B may also be angled accordingly to facilitate the locking in one direction.

A method of removing a bushing may be described more generally as follows. A shaft is inserted through each item of a set of items including a bushing housing and bushing assembly, a bushing engagement element for engaging the bushing and sized to fit within the bushing housing, a bushing housing engagement element for engaging the bushing housing and sized to contain the bushing, and a variable length element for providing a force. The bushing engagement element and the bushing housing engagement element are arranged abutting opposite ends of the bushing housing and bushing assembly. Pulling washer 22 is an example of a bushing engagement element and pulling sleeve 21 is an example of a bushing housing engagement element. Hydraulic ram 25 and hydraulic cylinder 24 together comprise an example of a variable length element for providing a force. A first securing element and a second securing element are provided on the shaft for securing the set of items between the first securing element and the second securing element. By making at least one of the first securing element and second securing element a directional locking device, the directional locking device can be conveniently slid on the shaft to reduce a distance between the directional self-locking device and the other of the first and second securing elements, while locking against an increase of that distance. A directional locking device defines a locking direction and a non-locking direction opposite to the locking direction, such that the directional self-locking device locks against motion of the device in the locking direction and allows motion of the device in the non-locking direction. The directional self-locking device is arranged on the shaft with the locking direction oriented away from the other of the first and second securing elements to lock against motion of the directional self-locking device on the shaft away from the other of the first and second securing elements. In the embodiment described above, the securing nut 10 is the first securing element and is threaded onto a threaded end of the shaft, and the releasable locking device is the second securing element. A non-releasable directional locking device could also in principle be used, as the nut and set of items could be removed from the shaft first and the directional locking device slid off the shaft in the non-locking direction. A releasable locking device is however more conveniently removable. It is not necessary for both securing elements to be removable. For example, a built in head of the shaft could be used as the first securing element instead of the nut in the embodiment above. It is not necessary for the items to be arranged on the shaft in the order described in the embodiment above. In order to remove the bushing, the variable length element is operated to increase a length of the variable length element. The first and second securing element constraining an overall length of the set of items on the shaft to the distance between the directional self-locking device and the other of the first and second securing elements, thereby forcing the bushing engagement element to move towards the bushing housing engagement element and move the bushing relative to the bushing housing. For clarity, the overall length of the set of items refers to a distance between portions of the items that contact the securing elements in operation and the distance between the securing elements refers to a distance between portions of the securing elements that contact the items in operation. It should be noted that the engagement elements need not be separate elements. The variable length element could be shaped to act as one of the engagement elements and either of the securing elements could be shaped to act as an engagement element. In the case that a securing element is shaped to act as an engagement element, then the overall length of the set of items refers to an overall length including an engagement portion of the securing element, and the distance between the securing elements refers to a distance extending to a boundary between the engagement portion of the securing element and a remainder of the securing element. If the above steps do not sufficiently move the bushing relative to the bushing housing to remove the bushing from the bushing and bushing housing assembly, then the variable length element may be allowed to reduce in length and the directional locking device again slid along the shaft to reduce the distance between the directional self-locking device and the other of the first and second securing elements. The variable length element can then be operated again to again force the bushing engagement element to move towards the bushing housing engagement element and move the bushing relative to the bushing housing. These steps can be repeated until the bushing is removed from the bushing housing assembly.

The same method may be used mutatis mutandis to install a bushing in a bushing housing. For installation of a bushing in a bushing housing, as the bushing and bushing housing are to be moved together and not apart from one another, it is not necessary to use a bushing housing engagement element and a bushing engagement element. These elements may of course still be used. The set of items will include a bushing housing and a bushing arranged adjacent to the bushing housing.

It will be apparent to one skilled in the art from the above examples that the disclosed invention offers advantages over the conventional “threaded shaft method”. Unlike that method, there is no requirement in the disclosed method (other than to secure the securing nut 10) to turn various nuts on a threaded shaft; any savings in terms of time, effort and frustration, are amplified further where a bushing must be pulled out or installed in several cycles, and where numerous bushings are required to be removed together.

1-2. (canceled)

3. A releasable self-locking device for installation upon a central shaft, wherein the releasable self-locking device is arranged to define a non-locking direction in which the releasable self-locking device is readily slidable along the central shaft and a locking direction opposite to the non-locking direction in which the releasable self-locking device locks against sliding movement along the central shaft, the releasable self-locking device comprising:
a main body having a bore for receiving the central shaft;
jaws mounted within the main body on surfaces that confine the jaws to move along a trajectory that moves the jaws towards the central shaft when the jaws are moved in the non-locking direction relative to the main body;
a spring or springs disposed between the main body and the jaws to bias the jaws in the non-locking direction relative to the main body; and
a release ring mounted on the main body and slidable relative to the main body against the spring or springs for moving the jaws in the locking direction relative to the main body.

4. The releasable self-locking device of claim 3 in which the surfaces are sliding surfaces that are angled with respect to the central shaft.

5. The releasable self-locking device of claim 3 in which the surfaces define a pivot that the jaws rotate around.

6. The releasable self-locking device of claim 3 wherein the central shaft is hexagonal in cross-section.

7. The releasable self-locking device of claim in which there are three jaws at 120 degrees to each other.

8. A method of removing the bushing of a bushing housing and bushing assembly, the method comprising the steps of:
inserting a shaft through each item of a set of items including the bushing housing and bushing assembly, a bushing engagement element for engaging the bushing and sized to fit within the bushing housing, a bushing housing engagement element for engaging the bushing housing and sized to contain the bushing, and a variable length element for providing a force, the bushing engagement element and the bushing housing engagement element arranged abutting opposite ends of the bushing housing and bushing assembly;
providing a first securing element and a second securing element on the shaft for securing the set of items between the first securing element and the second securing element, at least one of the first and second securing elements being a directional self-locking device, the directional self-locking device defining a locking direction and a non-locking direction opposite to the locking direction, the directional self-locking device being arranged on the shaft with the locking direction oriented away from the other of the first and second securing elements to lock against motion of the directional self-locking device on the shaft away from the other of the first and second securing elements;
sliding the directional self-locking device along the shaft to reduce a distance between the directional self-locking device and the other of the first and second securing elements; and
operating the variable length element to increase a length of the variable length element, the first and second securing element constraining an overall length of the set of items on the shaft to the distance between the directional self-locking device and the other of the first and second securing elements, thereby forcing the bushing engagement element to move towards the bushing housing engagement element and move the bushing relative to the bushing housing.

9. The method of claim 8 further comprising the step of allowing the variable length element to reduce in length and repeating the steps of sliding the directional self-locking device along the shaft to reduce the distance between the directional self-locking device and the other of the first and second securing elements and operating the variable length element to increase the length of the variable length element.

10. The method of claim 8 or claim 9 in which the first securing element is a nut threaded onto a threaded end of the shaft and the second securing element is the directional self-locking device.

11. The method claim 8 in which the directional self-locking device is a releasable self-locking device.

12. The method of claim 11 further comprising the step of releasing the releasable self-locking device and removing the releasable self-locking device from the shaft after the bushing has been moved sufficiently relative to the bushing housing to remove the bushing from the bushing housing.

13. The method of claim 11 in which the releasable self-locking device comprises:
a main body having a bore for receiving the shaft
jaws mounted within the main body on surfaces that confine the jaws to move along a trajectory that moves the jaws towards the shaft when the jaws are moved in the non-locking direction relative to the main body;
a spring or springs disposed between the main body and the jaws to bias the jaws in the non-locking direction relative to the main body; and
a release ring mounted on the main body and slidable relative to the main body against the spring or springs for moving the jaws in the locking direction relative to the main body.

14. A method of installing a bushing into a bushing housing, the method comprising the steps of:
inserting a shaft through each item of a set of items including a bushing housing, a bushing arranged adjacent to the bushing housing, and a variable length element for providing a force;
providing a first securing element and a second securing element on the shaft for securing the set of items between the first securing element and the second securing element, at least one of the first and second securing elements being a directional self-locking device, the directional self-locking device defining a locking direction and a non-locking direction opposite to the locking direction, the directional self-locking device being arranged on the shaft with the locking direction oriented away from the other of the first and second securing elements to lock against motion of the directional self-locking device on the shaft away from the other of the first and second securing elements;
sliding the directional self-locking device along the shaft to reduce a distance between the directional self-locking device and the other of the first and second securing elements; and
operating the variable length element to increase a length of the variable length element, the first and second securing element constraining an overall length of the set of items on the shaft to the distance between the directional self-locking device and the other of the first and second securing elements, thereby forcing the bushing to move into the bushing housing.

15. The method of claim 14 further comprising the step of allowing the variable length element to reduce in length and repeating the steps of sliding the directional self-locking device along the shaft to reduce the distance between the directional self-locking device and the other of the first and second securing elements and operating the variable length element to increase the length of the variable length element.

16. The method of claim 14 in which the first securing element is a nut threaded onto a threaded end of the shaft and the second securing element is the directional self-locking device.

17. The method of claim 14 in which the directional self-locking device is a releasable self-locking device.

18. The method of claim 17 further comprising the step of releasing the releasable self-locking device and removing the releasable self-locking device from the shaft after the bushing has been moved sufficiently into the bushing housing to install the bushing in the bushing housing.

19. The method of claim 17 in which the releasable self-locking device comprises:
a main body having a bore for receiving the shaft;
jaws mounted within the main body on surfaces that confine the jaws to move along a trajectory that moves the jaws towards the shaft when the jaws are moved in the non-locking direction relative to the main body;
a spring or springs disposed between the main body and the jaws to bias the jaws in the non-locking direction relative to the main body; and
a release ring mounted on the main body and slidable relative to the main body against the spring or springs for moving the jaws in the locking direction relative to the main body.
